(19) United States
(12) Patent Application Publication
(10) Pub. No.: US 2026/0269294 A1
(43) Pub. Date: Sep. 10, 2026

(54) METHOD FOR PRODUCING A CERIUM-GADOLINIUM OXIDE POWDER, IN PARTICULAR INTENDED FOR THE PRODUCTION OF AN ELECTROLYTE

(71) Applicant: SAINT-GOBAIN CENTRE DE RECHERCHES ET D’ETUDES EUROPEEN, COURBEVOIE (FR)

(72) Inventor: Nadia FREDERICH, L’ISLE SUR LA SORGUE (FR)

(21) Appl. No.: 19/165,119

(22) PCT Filed: Mar. 15, 2024
(86) PCT No.: PCT/EP2024/057033

§ 371 Date: Sep. 13, 2025

(30) Foreign Application Priority Data
Mar. 17, 2023 (FR) FR2302511

(51) Int. Cl. H01M 8/1016; C25B 13/05

(52) U.S. Cl. CPC H01M 8/1016; C25B 13/05

(57) ABSTRACT

A method is provided for producing a gadolinium-doped cerium oxide powder having a cobalt oxide. The method includes successive steps of preparing a wet product having a mixture of particles of gadolinium-doped cerium oxide and water containing a cobalt complex. The method includes optionally removing at least some of the water. If at least some of the water is removed the product is calcinated to obtain the powder, and it at least some of the water is not removed calcinating the product in in an oxygenated fluid to obtain the powder.

### TECHNICAL FIELD

The invention relates to a process for manufacturing a powder based on gadolinium-doped cerium oxide. The invention also relates to a process for manufacturing a sintered product, in particular an electrolyte, and also to a solid oxide fuel cell and a solid oxide electrolysis cell including such an electrolyte. Finally, the invention relates to the gadolinium-doped cerium oxide powder obtained or that may be obtained according to the process of the invention.

### PRIOR ART

In the field of solid oxide fuel cells (or “SOFC”) and solid oxide electrolysis cells (or “SOEC”), gadolinium-doped cerium oxide (or “GCO”), used as an electrolyte, represents an advantageous alternative to yttrium-stabilized zirconia due to its higher ion conductivity at lower operating temperatures (500° C.-700° C.).

During the manufacture of the electrolyte, a high sintering temperature, greater than or equal to 1500° C., is necessary to obtain high densification of the GCO. This conventionally results in a reduction in mechanical properties in association with an enlargement of the microstructure.

In order to obtain high densification at lower temperatures, it is known practice to use nanometric GCO powders and/or to use a small amount of transition metal oxides, such as cobalt, copper, nickel, manganese or iron, as sintering agent.

The addition of cobalt oxide to the GCO powder is conventionally performed by suspending a GCO powder in ethanol, followed by the addition of cobalt dinitrate dissolved in ethanol, drying and calcination, for example at 400° C., the calcination enabling the cobalt dinitrate to be converted into cobalt oxide.

There is an ongoing need to improve the process for manufacturing a sintered electrolyte.

One aim of the invention is to meet this need, at least in part.

### SUMMARY OF THE INVENTION

The invention proposes a process for manufacturing a gadolinium-doped cerium oxide powder including a cobalt oxide, or “Co-GCO powder”, said process including the following successive steps:
1) preparation of a wet product including, preferably consisting of, a mixture of:
   gadolinium-doped cerium oxide particles;
   water containing a cobalt complex;
the wet product preferably having a ratio Q_{Co}′/Q_{GCO}′ such that 0.005≤Q_{Co}′/Q_{GCO}≤0.15,
Q_{GCO}′ denoting the sum of the molar amounts of cerium and gadolinium in the wet product, and
Q_{Co}′ denoting the molar amount of cobalt in the wet product,
d) optionally, removing at least a portion of the water;
e) calcination of the product obtained from step d), or, in the absence of step d), obtained from step 1), in an oxygenated fluid, so as to obtain said Co-GCO powder.

Surprisingly and inexplicably, the inventors have discovered that the sintering of the powder according to the invention is improved.

The Co-GCO particles have the form of gadolinium-doped cerium oxide particles covered with cobalt oxide particles. The covering is particularly homogeneous.

In a preferred embodiment, the process includes step d) and step 1) includes the following steps:
a) suspending a gadolinium-doped cerium oxide powder in water;
b) adding to the suspension at least one water-soluble cobalt compound, or “first reagent”, so as to form cobalt cations, the amount of first reagent preferably being determined such that 0.005≤Q_{Co}/Q_{GCO}≤0.15, Q_{GCO} denoting the sum of the molar amounts of cerium and gadolinium provided in step a) and Q_{Co} denoting the molar amount of cobalt provided by the first reagent;
c) adding to the suspension at least one water-soluble cobalt ligand and/or at least one precursor of said ligand, or “second reagent”, so as to form a cobalt complex.

A process according to the invention may also include one or more of the following optional and preferred features:
the ratio Q_{Co}′/Q_{GCO}′ is greater than or equal to 0.01, preferably greater than or equal to 0.02, and less than or equal to 0.10, preferably less than or equal to 0.05, and/or in which, in step b), the ratio Q_{Co}/Q_{GCO} is greater than or equal to 0.01, preferably greater than or equal to 0.02 and less than or equal to 0.10, preferably less than or equal to 0.05;
the molar content of gadolinium in the gadolinium-doped cerium oxide powder of said wet product and/or of the powder suspended in step a), expressed as a percentage based on the sum of the molar contents of cerium and gadolinium, is greater than or equal to 10% and less than or equal to 20%;
in step a), the median size of the gadolinium-doped cerium oxide powder is greater than 20 nm and less than 0.8 μm;
the gadolinium-doped cerium oxide powder of said wet product and/or the powder suspended in step a) is obtained via a melting process;
the first reagent has a solubility in water, measured at 20° C., of greater than 300 g/l;
the first reagent is chosen from cobalt dinitrate, cobalt acetate, cobalt acetylacetonate, cobalt dichloride, cobalt difluoride, cobalt sulfate, cobalt tartrate, cobalt bromide, cobalt iodide, cobalt thiocyanate, cobalt phosphate, and mixtures thereof, and/or the second reagent is chosen from molecules including an amino group (—NH₂) and/or a carboxylate group (—COO⁻) and/or a thiol group (—SH);
the first reagent is chosen from cobalt dinitrate, cobalt acetate, and mixtures thereof, and/or the second reagent is chosen from urea and derivatives thereof, citric acid, oxalic acid, ethylenediamine, salen, ethylenediaminetetraacetic acid, and mixtures thereof;
the first reagent is cobalt dinitrate and/or the second reagent is chosen from urea and derivatives thereof;
in step c), the amount of the second reagent is adapted so that more than 99% of the amount of cobalt cations in the suspension are complexed;
in step c), the second reagent contains only carbon, hydrogen and oxygen atoms, and optionally nitrogen and/or chlorine atoms;
in step d), more than 80% by mass of the water is removed;
in step e), the calcination temperature is greater than 300° C. and less than 800° C., the holding time at said temperature being preferably greater than 1 hour and less than 10 hours.

The invention also relates to a gadolinium-doped cerium oxide powder including a cobalt oxide, said powder having the following chemical analysis, as mass percentages based on oxides:
more than 9.60% and less than 20.79% of Gd₂O₃, and
more than 72.55% and less than 89.32% of CeO₂, and
more than 0.23% and less than 6.51% of cobalt oxide expressed as CO₃O₄, and
less than 2% of oxides other than Gd₂O₃, CeO₂ and cobalt oxide expressed as CO₃O₄, the powder of gadolinium-doped cerium oxide particles being at least partially coated with cobalt oxide particles, so as to have a difference N₉₀−N₁₀, or “E value”, greater than 110,
   N₁₀ and N₉₀ being,
   on cobalt mapping
made up of pixels, each pixel having a shade of a color, said shade being between 0 and 255, and
produced by energy spectrometry on a pellet consisting of a compression of the powder at a pressure of 125 MPa,
   the shades corresponding to the percentages by number of said pixels of 10% and 90% respectively, on the cumulative distribution curve of the pixels, as a function of the shades, without taking into account the pixels having the shade 0, the shades being classified in ascending order, a shade being proportionately higher the higher the cobalt content.

Preferably, the E value is greater than 125 and/or the powder has an S value of less than 2.20, preferably less than 2.00, the S value being the ratio (N₉₀−N₁₀)/N₅₀, in which N₅₀ is the shade corresponding to the percentage by number of said pixels of 50% on said cumulative distribution curve.

The color may be, for example, green.

Preferably, the powder is manufactured by means of a process according to the invention.

The invention also relates to a process for manufacturing a sintered part, including a step f) of manufacturing a preform from a powder according to the invention, preferably manufactured or capable of being manufactured by a process for manufacturing a powder according to the invention, followed by a step g) of sintering the preform so as to obtain a sintered part.

The sintering of the preform is preferably performed at a temperature below 1500° C., preferably below 1490° C.

The invention also relates to a process for manufacturing a device chosen from a solid oxide fuel cell and a solid oxide electrolysis cell, including the manufacture of a sintered part from a powder that is manufactured or that may be manufactured by a process for manufacturing a powder according to the invention, said sintered part being found after manufacture between electrodes of said fuel cell or of said electrolysis cell so as to constitute an electrolyte.

Said process preferably includes the manufacture of a sintered part manufactured by means of a process according to the invention, said sintered part being found after manufacture between electrodes of said fuel cell or of said electrolysis cell so as to constitute an electrolyte.

The invention also relates to a wet product including gadolinium-doped cerium oxide particles in water containing a cobalt complex. The invention also relates to Co-GCO powder that is obtained or that may be obtained according to a process of the invention.

Finally, the invention relates to the sintered part, in particular the electrolyte, and the device obtained according to a process of the invention.

### BRIEF DESCRIPTION OF THE FIGURES

Other features and advantages of the invention will also emerge on examining the following description and the attached drawing, in which:

FIG. 1 represents an image taken using a scanning electron microscope of particles of the powder of Example 1, outside the invention:

FIG. 2 represents cobalt mapping produced by energy dispersive spectroscopy (or “EDS”) of the same particles as those present in FIG. 1;

FIG. 3 represents a photograph taken using a scanning electron microscope of particles of the powder of Example 2, according to the invention;

FIG. 4 represents cobalt mapping produced by EDS on the same particles as those shown in FIG. 2;

FIG. 5 represents the cumulative distribution of pixels, as a function of shades, for the mapping in Examples 1, 2, and 3, as a continuous line for Example 1 (the percentiles N₁₀, N₅₀, and N₉₀ being marked), as a dotted line for Example 2, and as a mixed line for Example 3.

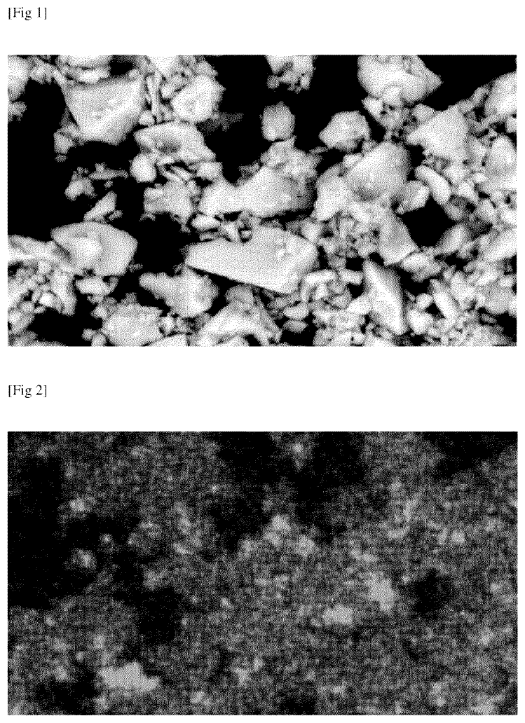

FIGS. 1 to 4 were all produced at the same magnification.

### DEFINITIONS

A “cobalt complex” is a compound conventionally formed by the combination of at least one cobalt cation with molecules or ions which can provide an electron doublet to said cobalt cation(s). These doublet donors are conventionally called “ligands”.
The percentiles or “centiles” 50 (D₅₀) and 90 (D₉₀) of a powder are the particle sizes corresponding to the volume percentages of 50% and 90%, respectively, on the cumulative particle size distribution curve of the powder, the particle sizes being classified in ascending order. For example, 90% by volume of the powder particles have a size less than D₉₀ and 10% by volume of the particles have a size greater than D₉₀. The percentiles may be determined using a particle size distribution performed using a laser particle size analyzer.
The fiftieth percentile of a powder is called the “median size” of said powder.
The term “impurities” means unavoidable constituents that are unintentionally and necessarily introduced with the raw materials or resulting from reactions with these constituents. Impurities are not necessary constituents, but are merely tolerated. Preferably, the mass percentage of impurities is less than 2%, less than 1%, less than 0.5%, or even substantially zero.
The verbs “comprise,” “include” and “have” shall be interpreted in a non-restrictive manner, unless otherwise indicated.

### DETAILED DESCRIPTION

Other features and advantages of the present invention will be also emerge on reading the detailed description of a preferred embodiment which follows, which is provided for illustrative purposes and without implied limitation.

In particular, step 1) described in detail includes steps a) to c). However, a person skilled in the art may consider other known techniques for manufacturing the wet product.

All the preferred features for the GCO powder used in step a), and notably the features relating to particle size distribution and the gadolinium content, are also preferred features for the GCO powder of step 1).

Similarly, the ratio Q_{Co}′/Q_{GCO}′ is preferably such that 0.005≤Q_{Co}′/Q_{GCO}′≤0.15, with Q_{GCO}′ denoting the sum of the molar amounts of cerium and gadolinium in the wet product, and Q_{Co}′ denoting the molar amount of cobalt in the wet product. Preferably, the ratio Q_{Co}′/Q_{GCO}′ is greater than or equal to 0.01, preferably greater than or equal to 0.02 and less than or equal to 0.10, preferably less than or equal to 0.05.

### Process for Manufacturing a Powder According to the Invention

In step a), a GCO powder is suspended in water.

The GCO powder may be manufactured via any conventional process. In a preferred embodiment, the GCO powder is obtained via a melting process, preferably an arc furnace melting process.

The molar content of gadolinium in the GCO powder, expressed as a percentage based on the sum of the molar contents of cerium and gadolinium, is preferably greater than or equal to 10%, and preferably less than or equal to 20%. In one embodiment, this content is equal to 10%. In one embodiment, this content is equal to 20%.

Preferably, the median size of the gadolinium-doped cerium oxide powder is greater than 20 nm, preferably greater than 30 nm, preferably greater than 50 nm, preferably greater than 0.1 μm, and preferably less than 0.8 μm, preferably less than 0.6 μm, preferably less than 0.4 μm.

Preferably, the D₉₀ of the gadolinium-doped cerium oxide powder is less than 2.5 μm, preferably less than 2 μm.

Water is preferred, but other equivalent solvents are possible.

Water preferably represents more than 30%, preferably more than 40%, preferably more than 45% and/or less than 90%, preferably less than 80%, preferably less than 70%, preferably less than 60%, preferably less than 55% of the mass of the suspension.

The GCO powder and water together preferably represent more than 95%, more than 98%, and preferably more than 99% of the mass of the suspension, the remainder to 100% preferably consisting of impurities.

Preferably, the suspension contains only water and GCO powder.

The suspension is conventionally prepared by simple mixing.

In step b), the first reagent, chosen from the water-soluble cobalt compounds and mixtures thereof, is added to the suspension. The object of step b) is to form cationic cobalt in the suspension.

The sum of the molar amounts of cerium and gadolinium, Q_{GCO}, provided in step a) and the molar amount of cobalt introduced by the first reagent, Q_{Co}, in step b) are such that 0.005≤Q_{Co}/Q_{GCO}≤0.15.

Preferably, the ratio Q_{Co}/Q_{GCO} is greater than or equal to 0.01, preferably greater than or equal to 0.02 and/or preferably less than or equal to 0.10, preferably less than or equal to 0.05.

Any water-soluble cobalt compound is suitable for use, with highly soluble water-soluble cobalt compounds being preferred.

Preferably, the first reagent has a solubility in water, measured at 20° C., of greater than 50 g/l, preferably greater than 100 g/l, preferably greater than 150 g/l, preferably greater than 200 g/l, preferably greater than 250 g/l, preferably greater than 300 g/l, and/or less than 1000 g/l.

Preferably, the first reagent is chosen from cobalt dinitrate, in particular hydrated cobalt dinitrate, cobalt acetate, cobalt acetylacetonate, cobalt dichloride, in particular hydrated cobalt dichloride, cobalt difluoride, cobalt sulfate, in particular hydrated cobalt sulfate, cobalt tartrate, cobalt bromide, cobalt iodide, cobalt thiocyanate, cobalt phosphate, and mixtures thereof. Preferably, the first reagent is chosen from cobalt dinitrate, in particular hydrated cobalt dinitrate, cobalt acetate, cobalt dichloride, in particular hydrated cobalt dichloride, cobalt sulfate, in particular hydrated cobalt sulfate, cobalt bromide, cobalt iodide, cobalt thiocyanate, and mixtures thereof. Preferably, the first reagent is chosen from cobalt dinitrate, in particular hydrated cobalt dinitrate, cobalt acetate, and mixtures thereof. More preferably, the first reagent is cobalt dinitrate, in particular hydrated cobalt dinitrate, preferably cobalt dinitrate hexahydrate.

Preferably, the first reagent is introduced with water in the form of an aqueous solution.

Preferably, step b) is performed with stirring.

In step c), the second reagent is added to the suspension obtained from step b). Preferably, the second reagent consists of a water-soluble cobalt ligand. Alternatively, or in addition, a precursor of such a ligand may be added, i.e. a compound which, after being added to the suspension, produces said ligand, for example a precursor which decomposes in water to release the cobalt ligand.

The ligand has the function of reacting with the cobalt cations resulting from the addition of the first reagent, so as to form cobalt complexes.

Preferably, the cobalt ligand is a cobalt-chelating ligand.

Preferably, the ligand is a strong field ligand.

The amount of said second reagent is preferably adapted so that more than 99% and preferably all of the cobalt cations of the suspension are complexed. Preferably, the second reagent contains only carbon, hydrogen and oxygen atoms, and optionally nitrogen and/or chlorine atoms.

Preferably, the second reagent is chosen from molecules including an amino group (—NH₂) and/or a carboxylate group (—COO⁻) and/or a thiol group (—SH). Preferably, the second reagent is chosen from molecules including an amino group (—NH₂) and/or a carboxylate group (—COO⁻).

Preferably, the second reagent is chosen from urea and derivatives thereof, citric acid, oxalic acid, ethylenediamine, salen, ethylenediaminetetraacetic acid (or “EDTA”), and mixtures thereof.

Preferably, the second reagent is chosen from urea and derivatives thereof, ethylenediamine, and mixtures thereof.

More preferably, the second reagent is chosen from urea and derivatives thereof.

Preferably, the second reagent is introduced with water, in the form of an aqueous solution.

Preferably, step c) is performed with stirring. In one embodiment, the suspension is preferably maintained at a temperature above 40° C., preferably above 50° C. and below 90° C., preferably below 80° C.

The order of steps a) to c) may be any one of the following: a)+b)+c) or a)+c)+b) or b)+a)+c) or b)+c)+a) or c)+b)+a) or c)+a)+b). In one embodiment, these steps are simultaneous.

The solution obtained after these steps may be termed a “complexed suspension”.

The amount of water in the complexed solution is not limited, except to limit the duration and/or cost of step d).

In step d), all or some of the water is extracted from the complexed suspension, preferably until a product having the consistency of wet sand or a powder is obtained. This extraction is preferably continued until more than 70% by mass of the water has been removed from the complexed suspension. Preferably, in step d), more than 80%, preferably more than 85%, preferably more than 90%, preferably more than 95% by mass of the water is removed from the complexed suspension.

In one embodiment, substantially all of the water is removed from the complexed suspension.

Any technique known to those skilled in the art for at least partially removing the water from the complexed suspension may be used, for example drying or freeze-drying.

When drying is performed in step d), it is preferably accompanied by stirring of the complexed suspension. Preferably, the drying temperature is above 50° C. and below 90° C., and the drying is preferably in air.

In step e), the product obtained from step d) is calcined.

Preferably, the calcination temperature is above 300° C., preferably above 400° C., and below 800° C. The holding time at this temperature is preferably more than 1 hour, preferably more than 2 hours and preferably less than 10 hours.

The calcination is performed in an oxygenated fluid, preferably in air.

In a non-preferred embodiment, steps d) and e) are performed simultaneously.

The Co-GCO powder obtained according to the invention proved to be particularly suitable for manufacturing a sintered product, in particular an electrolyte.

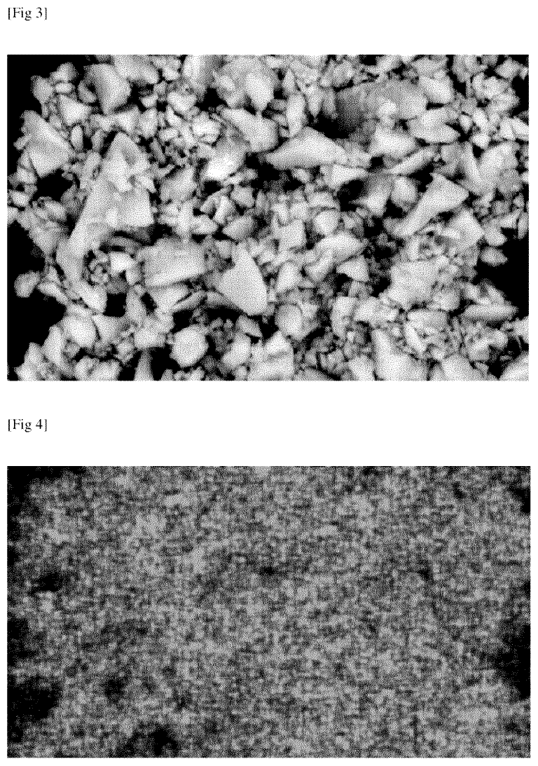

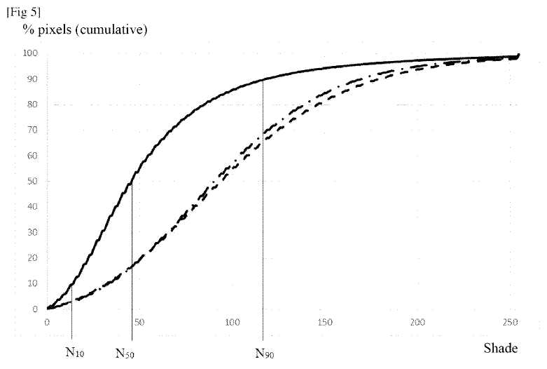

The inventors found that the surface of the gadolinium-doped cerium oxide particles is covered with cobalt oxide particles, the latter being spread in a remarkably homogeneous manner, as shown in FIGS. 2 and 4.

FIGS. 1 and 3 represent the particles of gadolinium-doped cerium oxide powder including cobalt oxide from Example 1 and Example 2, respectively. FIGS. 2 and 4 are superposable on FIGS. 1 and 3, respectively, but show the concentrations of cobalt. Cobalt appears gray in color, and the higher its concentration, the lighter the gray color. FIG. 2, produced on the powder of Example 1 outside the invention, shows a non-homogeneous distribution of the gray color, with numerous light-colored zones. In contrast, in FIG. 4, produced on the powder of Example 2 according to the invention, the gray color is distributed more homogeneously, representative of a more homogeneous distribution of cobalt on the surface of the GCO particles.

The cobalt oxide is cobalt (II, III) oxide expressed as CO₃O₄.

In the Co-GCO powder, not all of the cobalt oxide is necessarily located on the surface of the GCO particles.

The invention also relates to said Co-GCO powder which is manufactured or which may be manufactured according to a process for manufacturing a powder of the invention.

The term “percentiles N₁₀, N₅₀ and N₅₀” refers to, on cobalt mapping, in 256 shades of a color, produced on a pellet consisting of a compression of the powder at a pressure of 125 MPa, by energy spectrometry (or “EDS”), the shades corresponding to the percentages, as number of pixels of the mapping, of 10%, 50% and 90% respectively, on the cumulative distribution curve of the pixels, as a function of the shades, the shades being classified in ascending order, a shade being proportionately higher the higher the cobalt content.

In other words, 90% of the pixels in the mapping (percentage by number) have a shade lower than N₉₀ and 10% of the pixels have a shade lower than N₁₀.

The more pixels the mapping includes, the better the accuracy of the percentile evaluation. To increase the number of pixels, several zones of the pellet are preferably mapped.

The color whose shades are used may be chosen arbitrarily; for example, the shades in the examples are shades of bright green for cobalt.

The mapping may in particular be performed as described for the examples.

The E value is defined as the difference N₉₀−N₁₀, and the S value is defined as the ratio (N₉₀−N₁₀)/N₅₀=E/N₅₀.

The inventors consider that the manufacture by means of a process according to the invention results, on the Co-GCO powder, in particularly homogeneous covering of the particles with cobalt in oxide form. They also found an E value greater than 110.

Preferably, the E value is greater than 115, preferably greater than 120, preferably greater than 125, preferably greater than 130, preferably greater than 135.

More preferably, a powder according to the invention has an S value of less than 2.20, preferably less than 2.10, preferably less than 2.00, preferably less than 1.90, preferably less than 1.80, preferably less than 1.70, preferably less than 1.60.

This powder preferably includes, as mass percentages based on the oxides:
more than 9.60% and/or less than 20.79% of Gd₂O₃; and/or
more than 72.55% and/or less than 89.32% of CeO₂; and/or
more than 0.23%, preferably more than 0.50%, preferably more than 1.00%, preferably more than 1.50%, and/or less than 6.51%, preferably less than 5.50%, preferably less than 4.50%, preferably less than 3.50%, preferably less than 2.50% of cobalt oxide expressed as CO₃O₄, and/or
less than 2%, preferably less than 1% of oxides, preferably less than 0.5% of oxides other than Gd₂O₃, CeO₂ and cobalt oxide expressed as CO₃O₄.

The oxides represent more than 95%, preferably more than 98%, preferably more than 99%, preferably 100% of the mass of the Co-GCO powder.

Preferably, the median size of the Co-GCO powder is greater than 0.1 μm, and preferably less than 0.8 μm.

Preferably, the D₉₀ of the Co-GCO powder is less than 2.5 μm, preferably less than 2 μm.

### Process for Manufacturing a Sintered Part According to the Invention

In step f), the Co-GCO powder is worked into shape in the form of a “preform” using any conventional technique, and then, in step g), the preform is sintered.

Cooling produces the sintered part.

When the sintered part is intended to constitute an electrolyte, the shaping may be performed by tape casting or by screen printing of a slip generally containing the Co-GCO powder, a solvent, often water, a binder, generally a polymer, and a dispersant.

In a noteworthy manner, regardless of the embodiment, the sintering temperature may be less than 1600° C., preferably less than 1500° C., preferably less than 1490° C.

In one embodiment, the sintering of the preform can be performed at the same time as that of other constituents of a solid oxide fuel cell or a solid oxide electrolysis cell, for example the electrodes. This is referred to as co-sintering.

The sintered part obtained preferably constitutes an electrolyte.

### EXAMPLES

The invention is not limited to the embodiments provided as examples and described below.

To determine the chemical composition of a powder, a bead is manufactured by melting this powder. The content of the various elements is measured on this bead by X-ray fluorescence, oxygen being considered as the mass complement to 100%.

The median size of a powder is conventionally measured using a laser particle size analyzer of the LA950V2 model sold by the company Horiba.

In the examples, the following starting materials were used:
a gadolinium-doped cerium oxide powder, manufactured by melting in an arc furnace and having a molar content of gadolinium, expressed as a percentage based on the sum of the molar contents of cerium and gadolinium, equal to 20% and having a median size equal to 0.6 μm;
cobalt dinitrate hexahydrate, with a purity greater than 99% by mass;
for Example 1, ethanol with a purity greater than 99.9% by mass;
for Example 2, urea with a purity greater than 99% by mass.

The process for manufacturing gadolinium-doped cerium oxide powder produced by melting in an arc furnace is now described in greater detail.

A starting feedstock consisting of a cerium oxide powder and a gadolinium oxide powder is produced by mixing. Said starting feedstock is then melted in a single-phase Heroult-type electric arc furnace with graphite electrodes, with a furnace tank 0.8 m in diameter, a voltage of 195 V, a current of 1300 A and a specific electrical energy supplied of 3 kWh/kg charged. The molten material is then cast in the form of a trickle, and then dispersed as beads by blowing compressed air. After complete cooling, the beads are then heat treated in air at 1200° C. for a holding time at this temperature equal to 4 hours. After heat treatment, the beads are ground, first in a jar mill, then in a humid medium in a ball micromill so as to obtain, after drying, gadolinium-doped cerium oxide powder.

For Example 1, the following prior art process was performed.

6 g of gadolinium-doped cerium oxide powder are suspended in 100 mL of ethanol in a beaker at room temperature. 0.491 g of cobalt dinitrate hexahydrate, suspended in ethanol, is then added with stirring. This suspension is then dried with stirring on a hotplate at 60° C. for 1 hour, and then calcined in air in the following thermal cycle:
heating to 400° C. at a rate equal to 100° C./hour;
maintenance at 400° C. for 3 hours;
decreasing to 250° C. at a rate equal to 100° C./hour, followed by natural decrease to room temperature.

For Example 2, the process according to the invention was performed.

In step a), 150 g of gadolinium-doped cerium oxide powder are suspended in 400 mL of water in a beaker at room temperature. In step b), 12.3 g of cobalt dinitrate hexahydrate are added to the suspension with stirring. In step c), 7.59 g of urea are added to the suspension, with continued stirring for 1 minute after introduction of said urea. In step d), the complexed suspension obtained on conclusion of step c) is dried with stirring on a hotplate at 80° C. for 6 hours, and then calcined in step e) in air in the following thermal cycle:
heating to 400° C. at a rate equal to 100° C./hour;
maintenance at 400° C. for 3 hours;
decreasing to 250° C. at a rate equal to 100° C./hour, followed by natural decrease to room temperature.

For Example 3, the process according to the invention was performed.

In step a), 150 g of gadolinium-doped cerium oxide powder are suspended in 400 mL of water in a beaker at room temperature. In step b), 10.5 g of cobalt dinitrate hexahydrate are added to the suspension with stirring. In step c), 6.5 g of urea are added to the suspension, with continued stirring for 1 minute after introduction of said urea. In step d), the complexed suspension obtained on conclusion of step c) is dried with stirring on a hotplate at 80° C. for 6 hours, and then calcined in step e), in air, in the following thermal cycle:
heating to 400° C. at a rate equal to 100° C./hour;
maintenance at 400° C. for 3 hours;
decreasing to 250° C. at a rate equal to 100° C./hour, followed by natural decrease to room temperature.

The cumulative pixel distribution curve, as a function of shades, with shades classified in ascending order, was prepared in the following manner:

2 g of powder from each example are pressed at a pressure of 125 MPa in a 10 mm diameter die so as to obtain, for each example, a pellet. Each pellet is then metallized using a Sputter Coater 208HR metallizer sold by the company CRESSINGTON, fitted with a platinum target, the pellet being placed 10 cm from the target during the metallization operation, the spraying current intensity being equal to 40 mA.

Each pellet is then observed, in a mode using secondary electrons, using a GeminiSEM 560 scanning electron microscope (SEM) sold by the company ZEISS, equipped with an X Flash 6/60 model energy dispersive spectroscopy (EDS) probe sold by the company Bruker, under the following conditions:
Working Distance (WD): 10 mm,
High Voltage (HV): 20 keV,
Gun Mode: Analytic,
VP mode: 30 Pa,
Diaphragm: 120 pm,
Magnification: ×10 000.

To perform cobalt mapping on a pellet, five zones, each representing 11.4×8.6 μm², are mapped by energy dispersive spectrometry (or “EDS”) using the EDS probe and Esprit software, version 2.3.1.1019, developed by the company BRUKER, with the scan configuration defined using the following parameters:
image size [i.e. number of pixels]: 600,
Image inputs: signal A; none,
maps:
   time/points [μs]: 2048,
   line averaging: 1.

The images obtained represent the location and local content of cobalt: the more intense the color, the higher the local cobalt content, said color used being bright green.

The settings used, which can be found in the Combined mapping section, are as follows:
image filter: none
map filter: smoothing, value indicated: 3
combined image: raw signal
color control: the three parameters are not modified, the cursor for each parameter is located in the middle of the range, and the Co-Kα value is kept at 1.

The images obtained do not contain scale bars or other information of this type.

For each pellet, each of the five images is analyzed using the ImageJ software, available at https://imagej.net/ij/download.html, so as to assign to each pixel of said image a shade of green, the shades being between a value of 0 (black color representing the absence of cobalt, or even an absence of material) and 255 (the most intense color detected on the image, in other words the highest cobalt content).

Before analysis using the ImageJ software, the images are not processed in any way, notably to modify their contrast.

Each image is analyzed using the ImageJ software according to the following method:
open the image in ImageJ;
select Analyze, and then Histogram: ImageJ represents the distribution of pixels in the analyzed image in the form of a graph as a function of the shades;
select List to access the numerical data and copy them into a spreadsheet.

For each pellet, the sum of the pixels having said shade for all five images (i.e. for cobalt mapping) is determined for each shade, with shade 0 not being taken into account.

The curve representing the number of cumulative pixels, as a percentage, per shade value is then plotted, with the shades arranged in ascending order from 1 to 255. FIG. 5 represents, for Examples 1, 2 and 3, the cumulative distribution curve of the pixels, as a function of the shades, with the shades classified in ascending order.

The E value is defined as the difference N₉₀−N₁₀, where N₉₀ is the shade reached by 90% of the cumulative pixels, and N₁₀ is the shade reached by 10% of the cumulative pixels.

The S value is defined as the ratio (N₉₀−N₁₀)/N₅₀=E/N₅₀, N₅₀ being the shade reached by 50% of the cumulative pixels.

Table 1 below shows the features of the Co-GCO powders obtained.

TABLE 1

| | | |
|---|---|---|
| Powder of | Powder of | Powder of |
| Example 1 | Example 2 | Example 3 |

Chemical analysis (in mass percentages)

| | | | |
|---|---|---|---|
| Gd₂O₃ | 18.8 | 20.6 | 20.2 |
| CeO₂ | 78.7 | 76.8 | 76.5 |
| Cobalt oxide expressed as | 1.9 | 2.2 | 2.9 |
| Co₃O₄ | | | |
| Oxides other than Gd₂O₃, CeO₂ | 0.6 | 0.4 | 0.4 |
| and cobalt oxide expressed as | | | |
| Co₃O₄ | | | |
| Q_{Co}/Q_{GCO} | 0.042 | 0.049 | 0.065 |
| E Value | 105 | 147 | 137 |
| S Value | 2.28 | 1.58 | 1.51 |

The inventor found, surprisingly, that the sintering behavior of the powder of Example 2 according to the invention was better than that of the powder of Example 1, outside the invention.

In particular, after performing a thermal expansion test on a dry cylindrical sample from Examples 1 and 2, with a diameter equal to 10 mm and a height equal to 6 mm, on a TMA SETSYS EVO 1750 differential dilatometer sold by the company SETARAM KEP TECHNOLOGIES, fitted with a dense alumina sensor, with a rise rate equal to 1.6° C./min up to 1450° C., maintenance at 1450° C. for 1 hour and descent at a rate of 5° C./min, the curve of the derivative of the thermal expansion (in %/min) as a function of temperature shows a minimum value equal to 1362° C. for Example 1, outside the invention, and equal to 1250° C. for Example 2 according to the invention. The powder of Example 2 according to the invention therefore has a maximum shrinkage rate reached at a lower temperature (1250° C.) than for the powder of Example 1, outside the invention (1362° C.).

The invention thus allows the process for manufacturing an electrolyte to be improved.

Without being bound by this theory, the inventor explains this result by a remarkably more homogeneous dispersion of the cobalt oxide particles on the surface of the gadolinium-doped cerium oxide particles for the powder according to Example 2 according to the invention compared to the powder of Example 1 outside the invention, as illustrated in FIGS. 2 and 4: the value of E is equal to 147 for the powder of Example 2 according to the invention, and greater than the value of E, equal to 105, for the powder of Example 1.

Needless to say, the present invention is not limited to the embodiments described, which are provided as nonlimiting illustrative examples.

In particular, the products according to the invention are not limited to particular forms or dimensions.

1. A process for manufacturing a gadolinium-doped cerium oxide powder including a cobalt oxide, said process including the following successive steps:
1) preparation of a wet product including a mixture of:
gadolinium-doped cerium oxide particles;
water containing a cobalt complex;
d) optionally, removing at least a portion of the water;
e) calcination of the product obtained from step d) or, in the absence of step d), obtained from step 1), in an oxygenated fluid, so as to obtain said powder.

2. The process as claimed in claim 1, including step d) and wherein step 1) includes the following steps:
a) suspending a gadolinium-doped cerium oxide powder in water;
b) adding to the suspension at least one water-soluble cobalt compound, referred to as a first reagent, so as to form cobalt cations, the amount of first reagent being preferably determined so that 0.005≤Q_{Co}/Q_{GCO}≤0.15, Q_{GCO} denoting the sum of the molar amounts of cerium and gadolinium provided in step a) and Q_{Co} denoting the molar amount of cobalt provided by the first reagent;
c) adding to the suspension at least one water-soluble cobalt ligand and/or at least one precursor of such a ligand, referred to as a second reagent, so as to form a cobalt complex.

3. The process as claimed in claim 2, wherein the ratio Q_{Co}′/Q_{GCO}′ is greater than or equal to 0.01 and less than or equal to 0.10, and/or wherein, in step b), the ratio Q_{Co}/Q_{GCO} is greater than or equal to 0.01 and less than or equal to 0.10.

4. The process as claimed in claim 3, wherein the ratio Q_{Co}′/Q_{GCO}′ is greater than or equal to 0.02 and less than or equal to 0.05, and/or wherein, in step b), the ratio Q_{Co}/Q_{GCO} is greater than or equal to 0.02 and less than or equal to 0.05.

5. The process as claimed in claim 2, wherein the molar content of gadolinium in the gadolinium-doped cerium oxide powder of said wet product and/or of the powder suspended in step a), expressed as a percentage based on the sum of the molar contents of cerium and gadolinium, is greater than or equal to 10% and less than or equal to 20%.

6. The process as claimed in claim 2, wherein the median size of the gadolinium-doped cerium oxide powder of said wet product and/or of the powder suspended in step a) is greater than 20 nm and less than 0.8 μm.

7. The process as claimed in claim 2, wherein the gadolinium-doped cerium oxide powder of said wet product and/or of the powder suspended in step a) is obtained via a melting process.

8. The process as claimed in claim 2, wherein the first reagent has a solubility in water, measured at 20° C., of greater than 300 g/l.

9. The process as claimed in claim 2, wherein:
the first reagent is chosen from any one of cobalt dinitrate, cobalt acetate, cobalt acetylacetonate, cobalt dichloride, cobalt difluoride, cobalt sulfate, cobalt tartrate, cobalt bromide, cobalt iodide, cobalt thiocyanate, cobalt phosphate, and mixtures thereof, and/or
the second reagent is chosen from molecules including an amino group —NH₂ and/or a carboxylate group —COO⁻ and/or a thiol group —SH.

10. The process as claimed in claim 9, wherein:
the first reagent is chosen from cobalt dinitrate, cobalt acetate, and mixtures thereof, and/or
the second reagent is chosen from urea and derivatives thereof, citric acid, oxalic acid, ethylenediamine, salen, ethylenediaminetetraacetic acid, and mixtures thereof.

11. The process as claimed in claim 10, wherein the first reagent is cobalt dinitrate and/or the second reagent is chosen from urea and derivatives thereof.

12. process as claimed in claim 2, wherein, in step c), the amount of the second reagent is adapted so that more than 99% of the amount of cobalt cations in the suspension are complexed.

13. The process as claimed in claim 2, wherein, in step c), the second reagent contains only carbon, hydrogen and oxygen atoms, and optionally nitrogen and/or chlorine atoms.

14. The process as claimed in claim 1, wherein, in step d), more than 80% by mass of the water is removed.

15. The process as claimed in claim 1, wherein, in step e), the calcination temperature is above 300° C. and below 800° C., the holding time at said temperature being more than 1 hour and less than 10 hours.

16. A gadolinium-doped cerium oxide powder comprising:
a cobalt oxide, said powder having the following chemical analysis, as mass percentages based on the oxides:
more than 9.60% and less than 20.79% of Gd₂O₃, and
more than 72.55% and less than 89.32% of CeO₂, and
more than 0.23% and less than 6.51% of cobalt oxide expressed as Co₃O₄, and
less than 2% of oxides other than Gd₂O₃, CeO₂ and cobalt oxide expressed as Co₃O₄,
the powder of gadolinium-doped cerium oxide particles being at least partially coated with cobalt oxide particles, so that the difference N₉₀−N₁₀, or “E value”, is greater than 110,
N₁₀ and N₉₀ being,
on cobalt mapping
made up of pixels, each pixel having a shade of a color, said shade being between 0 and 255, and
produced by energy spectrometry on a pellet consisting of a compression of the powder at a pressure of 125 MPa,
the shades corresponding to the percentages by number of said pixels of 10% and 90% respectively, on the cumulative distribution curve of the pixels, as a function of the shades, without taking into account the pixels having the shade 0, the shades being classified in ascending order, a shade being proportionately higher the higher the cobalt content.

17. The powder as claimed in claim 16, having an E value greater than 125.

18. The powder as claimed in claim 16, having an S value of less than 2.20, the S value being the ratio (N₉₀−N₁₀)/N₅₀, where N₅₀ is the shade corresponding to the percentage by number of said pixels of 50% on said cumulative distribution curve.

19. The powder as claimed in claim 18, the S value being less than 2.00.

20. A process for manufacturing a sintered part, said process comprising a step f) of manufacturing a preform from a powder as claimed in claim 16,
or from a powder manufactured according to a process including
1) preparation of a wet product including a mixture of:
gadolinium-doped cerium oxide particles;
water containing a cobalt complex;
d) optionally, removing at least a portion of the water;
e) calcination of the product obtained from step d) or, in the absence of step d), obtained from step 1), in an oxygenated fluid, so as to obtain said powder,
followed by a step g) of sintering the preform so as to obtain a sintered part.

21. The process as claimed in claim 20, wherein the sintering temperature is below 1500° C.

22. A process for manufacturing a device chosen from a solid oxide fuel cell and a solid oxide electrolysis cell, said process comprising:
manufacture of a sintered part manufactured as claimed in claim 20, said sintered part being found after manufacture between electrodes of said fuel cell or of said electrolysis cell so as to constitute an electrolyte.

23. The process as claimed in claim 1, wherein the wet product preferably having a ratio Q_{Co}′/Q_{GCO}′ such that 0.005≤Q_{Co}′/Q_{GCO}′≤0.15, Q_{GCO}′ denoting the sum of the molar amounts of cerium and gadolinium in the wet product, and Q_{Co}′ denoting the molar amount of cobalt in the wet product.
